(19) United States
(12) Patent Application Publication
(10) Pub. No.: US 2024/0008506 A1
(43) Pub. Date: Jan. 11, 2024

(54) CONTAINMENT SYSTEM FOR A VOLUME OF ICE CREAM AND METHOD OF MAKING A CONSUMABLE PRODUCT USING THE CONTAINMENT SYSTEM

(71) Applicant: James Michael McLaughlin, Homewood, IL (US)

(72) Inventor: James Michael McLaughlin, Homewood, IL (US)

(21) Appl. No.: 17/860,706

(22) Filed: Jul. 8, 2022

(51) Int. Cl. A23G 9/50; B65D 85/78

(52) U.S. Cl. CPC A23G 9/506; B65D 85/78

(57) ABSTRACT

The combination of: a) a containment apparatus having an upwardly opening cup-shaped portion bounding a first open containment volume; b) a cover portion that extends at least partially over the first open containment volume to at least one of: i) partially block the first open containment volume; and ii) create an additional containment volume in communication with the first containment volume, wherein the cover portion is made at least partially from an edible material; and c) an ice cream product within at least the first containment volume.

### BACKGROUND OF THE INVENTION

### Field of the Invention

This invention relates to ice cream products and, more particularly, to a containment system for a volume of an ice cream product and a method of making a consumable product using the containment system.

### Background Art

Ice cream products are commonly placed in containers that can be held and transported by a person while he/she is consuming the ice cream product. As used herein, in descriptive portions and the claims, these products will be generically identified as “ice cream”, with it being understood that this term is intended to encompass a conventionally identified ice cream product, that may be dairy or non-dairy based, shaved ice products, etc., and essentially any formable edible product that can be dispensed into a container and will have some ability to maintain shape in a chilled/frozen state. For example, ice cream at a cold enough temperature will have some ability to at least temporarily maintain shape in a cup, as demonstrated when ice cream is overfilled in the cup.

One common form of containment apparatus/container is identified as a “cone” which, as used herein throughout, is intended to encompass any configuration, typically edible, having a receptacle for a volume of ice cream. The cone can take any shape from a simple conical shape, a truncated conical shape, a contoured conical shape, etc.

The most common type of cone is a molded cake-based material or a “waffle” or sugar based material that is formed with an open cup shape and a flat bottom surface to facilitate stable placement on a flat surface. The open top region facilitates delivery of the ice cream to a containment volume. Commonly, the ice cream is in a soft form that is either progressively compressed into the containment volume or built up therein as by spirally layering an ice cream stream.

Different volumes of ice cream are offered generally either by providing different size cones and/or by controlling the amount of overfill of the ice cream beyond an upper rim of the cone. The cone preparer will typically continue to discharge ice cream into the cone after the level reaches the upper rim of the cone. The ice cream accumulated above the upper rim is unstable in form and becomes less viscous and less stable as it increases in temperature. Consistent volume delivery from one cone to the next generally relies on the skill and perception of the preparer.

Thus, conventionally there is no practical way to control precisely the volume of ice cream introduced to an open cone. The “stack” of ice cream above the top of the cone is generally somewhat random in shape and volume, particularly when the ice cream is accumulated to several inches above the upper cone rim to offer larger sizes.

The inconsistently filled cone product resulting from inexperienced preparers may lead to customer dissatisfaction, particularly when a customer believes that he or she has been given less than another customer that purchased the same size product. Further, the inability to consistently deliver the same volume of ice cream from one cone to the next leads to inventory control problems.

Using scales to weigh each ice cream filled cone is a solution but generally impractical when preparation of ice cream filled cones is performed in high volume, which is common on warm days.

Another problem with conventional ice cream filled cones, as described above, is that they tend to maintain their integrity only for a very short period of time, particularly in warm environments, which as a practical matter is the most common environment in which ice cream products are consumed.

While the cone itself affords a level of insulation, the ice cream at the top of the cone, and that overfills the cone, is directly exposed and prone to melting rapidly in warm atmospheres and/or when exposed directly to the sun.

It is common to see persons holding cones with melted ice cream overflowing the cone and dripping down the outside cone surface that is gripped by the consumer so as to contact the consumer and/or drip to upon the consumer's clothes and surrounding objects. This problem is aggravated when the cone is tipped or bumped. While this may be a minor inconvenience outdoors, indoors escaping ice cream may create bigger staining problems. One advantage of eating ice cream from cones is that it affords an individual the comfort of consuming the ice cream while walking around, as indoors, or while sitting and moving in vehicles. Moving vehicles are one of the more common locations for ice cream staining given that moving vehicles are commonly used at drive throughs where ice cream cones are sold.

These problems are aggravated when the consumers are young and prone to tipping and holding the ice cream filled cones in orientations that promote escape of ice cream from the cone. The escaping ice cream tends to stain clothes, blankets, baby strollers, and baby carriers, as well as contacting those tending to the young consumers.

Aside from the potential staining of clothing and surrounding furniture and seating areas, overflowing melting ice cream may often create an inconvenience significant to the point that the consumer chooses to dispose of the ice cream cone before the ice cream and/or the cone are consumed.

Despite the fact that the above problems have been long known and populations have been contending with them for generations, the basic cone configuration remains a staple primarily given that there are no practical alternatives that afford the convenience of a cone without inheriting all its limitations.

### SUMMARY OF THE INVENTION

In one form, the invention is directed to the combination of: a) a containment apparatus having an upwardly opening cup-shaped portion bounding a first open containment volume; b) a cover portion that extends at least partially over the first open containment volume to at least one of: i) partially block the first open containment volume; and ii) create an additional containment volume in communication with the first open containment volume, wherein the cover portion is made at least partially from an edible material; and c) an ice cream product within at least the first containment volume.

In one form, the cover portion has an opening through which the ice cream product can be directed and into the first open containment volume.

In one form, the containment apparatus is made at least partially from an edible material.

In one form, the containment apparatus and the cover portion are separately formed components that are joined together.

In one form, the cover portion is made at least partially from an edible material. The containment apparatus and the cover portion are joined using an edible adhering composition.

In one form, the cover portion creates an additional containment volume in communication with the first open containment volume. The ice cream product is within the first open containment volume and the additional containment volume.

In one form, the edible material is a cake material containing at least one of wheat, flour, and sugar.

In one form, the cover portion has the shape of at least a part of an animate object, an identifiable inanimate object, and a logo.

In one form, there is a single piece that defines at least a part of the containment apparatus and the cover portion.

In one form, the containment apparatus is an off-the-shelf ice cream cone to which the cover portion is joined.

In one form, an edible syrup is applied between parts of the containment apparatus and the cover portion to maintain the joined containment apparatus and cover portion together.

In one form, there is a projection on one of the containment apparatus and cover portion that extends into a receptacle on the other of the containment apparatus and cover portion to facilitate consistent relative positioning of the joined containment apparatus and cover portion.

In one form, the cover portion has a wall that extends over at least a part of the first open containment volume as viewed from above.

In one form, the containment apparatus has an annular wall surface that is graspable in a hand of a user.

In one form, the annular wall surface has a tapering diameter between a top and bottom of the containment apparatus.

In one form, the containment apparatus has an annular outer wall surface between a top and bottom of the containment apparatus. The annular outer wall surface has a non-uniform diameter over at least a portion of the annular outer wall surface between the top and bottom of the containment apparatus.

In one form, the containment apparatus has a top and bottom, an annular outer wall, and an annular upwardly facing surface spaced from the top of the annular outer wall to be closer to the top of the containment apparatus than the bottom of the containment apparatus and made from an edible material to allow ice cream escaping from at least one of the first open containment volume and the additional containment volume to be accumulated at and consumed with the annular upwardly facing surface.

In one form, the invention is directed to the combination of the containment apparatus and cover portion as described above.

In one form, the invention is directed to a method of making a consumable product including the steps of: obtaining a containment apparatus and cover portion as described above; and directing a quantity of flowable ice cream product through the cover portion adequate to reside in each of the first open containment volume and the additional containment volume.

In one form, the step of obtaining a containment apparatus involves obtaining a containment apparatus wherein the cup-shaped portion and cover portion are separate components. The method further includes the step of directing ice cream product into the first open containment volume with the cover portion separated from the containment apparatus, and thereafter joining the cover portion with the containment apparatus.

In one form, the method further includes the step of directing additional ice cream product through the cover portion, and into at least one of the first open containment volume and the additional containment volume with the cover portion operatively joined to the containment apparatus.

### BRIEF DESCRIPTION OF THE DRAWINGS

FIG. 1 is a schematic representation of a containment apparatus and cover portion therefor, according to the invention, and defining a containment volume for an ice cream product;

FIG. 2 is a plan view of one exemplary form of containment apparatus as shown in FIG. 1;

FIG. 3 is a side elevation view of the containment apparatus in FIG. 2;

FIG. 4 is a cross-sectional view of the containment apparatus taken along line 4-4 of FIG. 2;

FIG. 5 is a cross-sectional view of the containment apparatus taken along line 5-5 of FIG. 2;

FIG. 6 is an exploded perspective view of the containment apparatus in FIGS. 2-5 with an exemplary form of cover portion, as shown schematically in FIG. 1;

FIG. 7 is a bottom view of the cover portion in FIG. 6;

FIG. 8 is an enlarged, fragmentary view showing connecting regions between the cover portion and containment apparatus as in FIG. 6 and with a sealing component therebetween;

FIG. 9 is a view as in FIG. 8 with a sealing component alternatively placed;

FIG. 10 is a schematic representation of a connection between the cover portion and containment apparatus according to the invention;

FIG. 11 is a reduced, side elevation view of an alternative form of containment apparatus and cover portion, according to the invention;

FIG. 12 is a view as in FIG. 3 of a modified form of containment apparatus and including a collecting collar and an alternative cover portion in the shape of a dinosaur;

FIG. 13 is a schematic representation showing alternative shapes for the inventive cover portion;

FIG. 14 is a schematic representation showing alternative shapes for the inventive containment apparatus; and

FIG. 15 is a flow diagram representation of a method of making a consumable product including an ice cream product in a containment apparatus with a cover portion, according to the invention.

### DETAILED DESCRIPTION OF THE PREFERRED EMBODIMENT

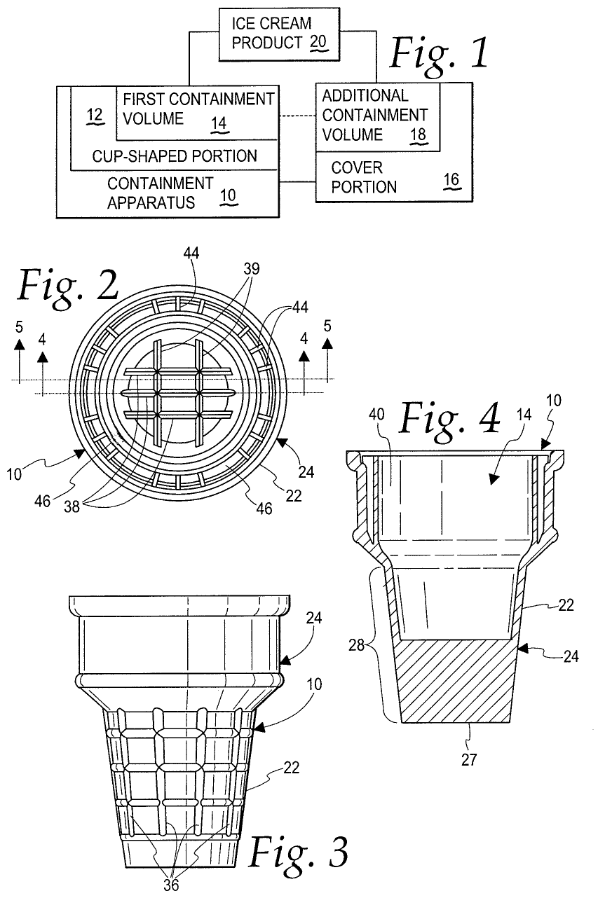

A containment apparatus, according to the present invention, is shown in schematic form in FIG. 1 at 10. The containment apparatus 10 has an upwardly opening cup-shaped portion 12 bounding a first open containment volume 14.

The containment apparatus 10 is provided in combination with at least one cover portion 16 that extends at least partially over the first open containment volume 14 to at least one of: a) partially block the first containment volume; and b) create an additional containment volume 18 in communication with the first containment volume 14, with the cover portion 16 operatively joined with the containment apparatus 10. The containment apparatus 10 and cover portion 16 together define a containment system for an ice cream product 20.

The ice cream product 20 is provided in at least the first containment volume 14. As noted in the Background Art section herein, “ice cream product” is intended to encompass any formable edible product that can be dispensed into a container and has some ability to maintain shape in a chilled/frozen state.

The characterization of the portion 12 as “cup-shaped” is not intended to be limited to any particular shape other than one that can confine the ice cream product 20 directed gravitationally into the first containment volume 14. The shape may be a simple common cup shape, a cone shape as described above, or a complicated shape or artistic shape that lends itself to being held or placed on a surface whereupon consumption of the ice cream product 20 can occur. For simplicity herein, the entire containment apparatus 10 will be considered to make up the cup-shaped portion 12.

As noted, while the cover portion 16 may simply partially block the open first containment volume 14 and not define any additional containment volume, more preferably, the cover portion 16 defines the additional containment volume 18, in communication with the first containment volume 14, to accommodate an additional quantity of the ice cream product 20.

The containment apparatus 10 may be edible or non-edible in form. As described in one preferred form below, the containment apparatus 10 is at least partially edible, or fully edible.

The cover portion 16 is preferably at least partially edible, and more preferably fully edible.

As noted, the containment apparatus 10 may be custom designed, with an unlimited number of different potential shapes, or may be a conventional off-the-shelf containment apparatus/cone that is adapted according to the invention. In FIGS. 2-5, a conventional cake cone is shown defining the containment apparatus 10. This form is exemplary in nature only and should not be viewed as in any way limiting.

The containment apparatus 10 in FIGS. 2-5 consists of a body 22 with a periphery wall 24 extending around a vertical central axis 26 and bounding a first containment volume 14 in conjunction with a bottom wall 27. A lower body region at 28 is generally conical in shape with a truncated bottom to facilitate placement stably upon a flat surface.

An upper region 30 of the body 22 is substantially cylindrical in shape and transitions into the lower region 28 at a stepped region 32.

A series of radially outwardly projecting annular ring shapes 34a, 34b, 34c, 34d, in conjunction with the stepped region at 32, facilitate positive grasping of the containment apparatus 10 in the hand of a user. Circumferentially spaced, axially extending ribs 36 project radially outwardly and also facilitate grasping of the containment apparatus 10 and additionally reinforce the lower body region 28.

Additional reinforcement is provided by inside, crossing wall sections 38, 39 and an inner cylindrical wall portion 40 radially inset from the upper body region 30 and defining in conjunction therewith an annular upper rim 42.

The upper body region 30 and inner wall portion 40 are bridged by circumferentially spaced ribs 44 between which circumferentially spaced gaps 46 of different dimension are defined.

The above-described details of the depicted containment apparatus 10 are arrived at by combining features that are ornamentally desired, functionally desired, selected to facilitate formation as by molding, etc.

In FIGS. 6 and 7, the containment apparatus in FIGS. 2-5 is shown in combination with an exemplary form of the cover portion 16. As depicted, the cover portion 16 has an inverted cup shape, shown as a hollow section of a sphere, which bounds the aforementioned additional containment volume 18.

The cover portion 16 has a bottom edge 48 that is configured to be placed against the rim 42 to support the cover portion 16 so that with the cover portion 16 and containment apparatus 10 operatively joined, the containment volumes 14, 18 are in communication with each other.

The cooperating configuration between the rim 42 and edge 48 is not limited. As depicted, the edge 48 has a generally complementary shape to the rim 42. That is, they are generally of matching annular shape that allows a potential abutting/nesting arrangement to be achieved. As further depicted, and optionally, the cover portion 16 has circumferentially spaced, depending projections 50 that may nest in the aforementioned gaps 46 to make a keyed connection that facilitates alignment of the axis 52 of the cover portion 16 with the axis 26 of the containment apparatus 10.

As noted, there is no particular critical cooperating configurational arrangement between the rim 42 and edge 48. What is desirable is that there be enough compatibility in shape that with the rim 42 and edge 48 abutted a substantial seal can be established therebetween to avoid leakage of ice cream product 20 with the cover portion 16 operatively joined with the containment apparatus 10. This compatibility may be accomplished without any additional structure or component.

Alternatively, as shown in FIG. 8, an edible adhering/sealing component 54 may be interposed between the rim 42 on the containment apparatus and the edge 48 on the cover portion 16. As just one example, an edible component, such as a syrup with significant viscosity, can be placed on the edge 48 to effect a seal between the engaged edge 48 and rim 42.

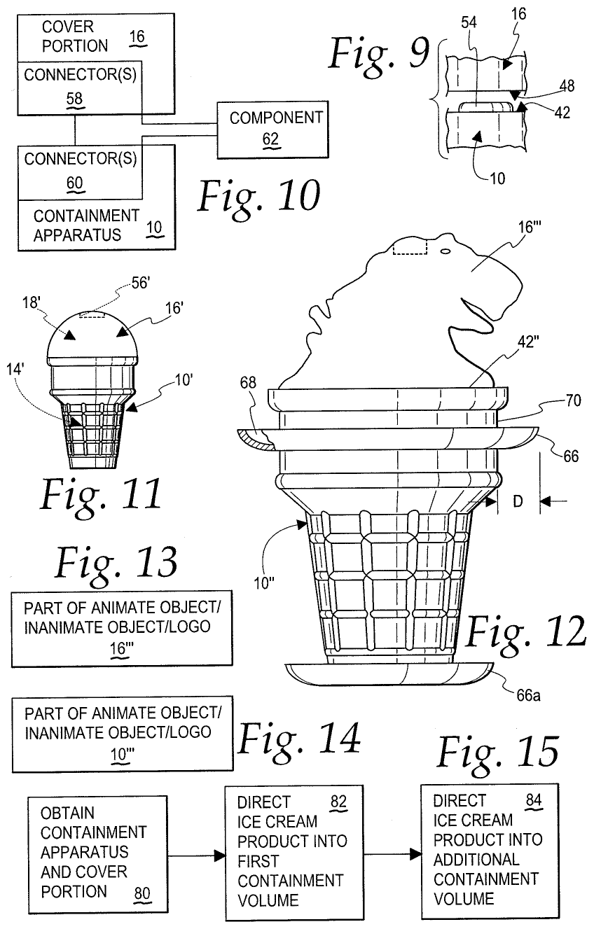

As shown in FIG. 9, a like component 54 can be provided on the rim 42 of the containment apparatus 10 to engage the edge 48 with the cover portion 16 operatively joined with the containment apparatus 10.

Generally, edible materials might be selected that are flowable and have sufficient viscosity that an adequate seal can be immediately effected upon pressing the cover portion 16 against the containment apparatus 10.

Alternatively, an edible component 54 might be applied and thereafter cooled to be solidified to enhance a sealed connection between the cover portion 16 and the containment apparatus 10.

In one preferred form, the cover portion 16 has an opening 56, preferably at a top region thereof, to communicate with the additional containment volume 18. The opening diameter may vary depending upon how the ice cream product 20 is delivered from a supply thereof.

As noted previously, the precise cooperation between the cover portion 16 and containment apparatus 10 is not limited. As shown schematically in FIG. 10, at least one connector 58 on the cover portion 16 may be configured to cooperate with at least one connector 60 on the containment apparatus 10. The connectors 58, 60 may be nothing more than abutting edges. Alternatively, the connectors 58, 60 may be made with specially designed complementary shapes that facilitate a press fit, frictionally maintained connection that may effect sealing with or without the addition of a component 62, as shown also in FIG. 10. The connectors may be axially overlapping surfaces on the cover portion 16 and containment apparatus 10—such as a telescoping connection.

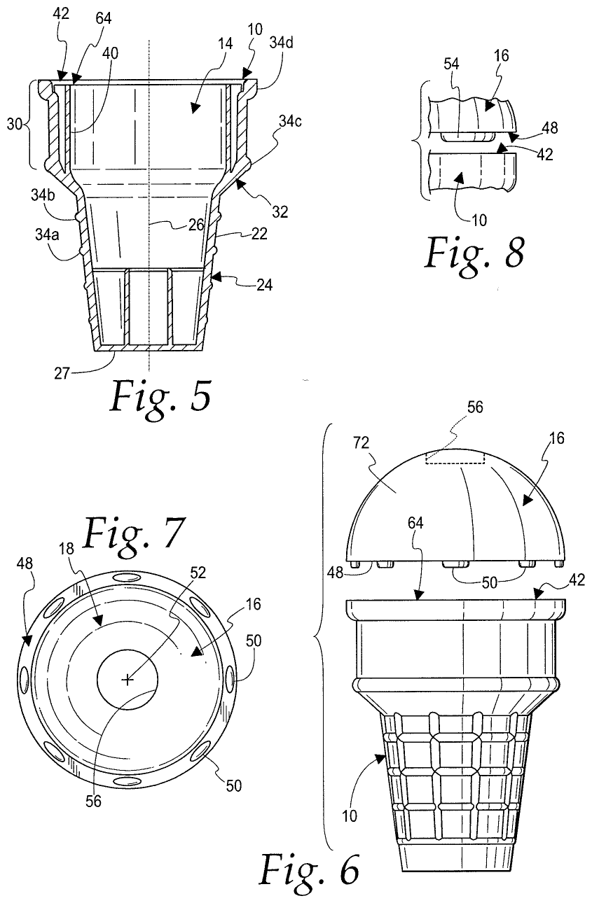

Ice cream product 20 can be introduced in different manners. For example, with the cover portion separated from the containment apparatus 10, ice cream product 20 can be directed through an upper opening 64 (see also FIG. 5) into the first containment volume 14. After a certain level of filling takes place, the cover portion 16 can be operatively joined, whereupon ice cream product 20 can be directed through the opening 56 causing an additional volume of the ice cream product 20 to be accumulated in the first containment volume 14 and/or in the additional containment volume 18, until the desired level is achieved. The cover portion 16 and containment apparatus 10 cooperatively produce an identifiable combined containment volume, made up of the first containment volume 14 and the additional containment volume 18, whereby an individual introducing the ice cream product is able to consistently portion the ice cream product 20.

As noted above, the cover portion 16 may be operatively joined to the containment apparatus 10 relying upon the cooperating connectors 58, 60 and/or by additionally employing the sealing component 62.

In an alternative form, as described below, the cover portion 16 and containment apparatus 10 may be unitarily formed, or joined, before introducing any ice cream product 20.

In another alternative process, the cover portion 16 and containment apparatus 10 may be joined using the component 62 that solidifies at lower temperatures. Thus, the pre-assembled cover portion 16 and containment apparatus 10 may be maintained as in a freezer to solidify the component 62. Most or all of the ice cream product 20 can be introduced after the frozen or chilled cover portion 16 and containment apparatus 10, in operatively joined relationship, are removed from the low temperature environment.

In an alternative form, as shown in FIG. 11, at least part of the containment apparatus 10′ and at least part of the cover portion 16′ may be defined as one piece with an opening 56′ through the cover portion 16′ to allow introduction of the ice cream product 20 into corresponding containment volumes 14′, 18′. The diameter of the opening 56′, as in all forms herein, is dictated by the filling method. For example, a small diameter discharge nozzle for the ice cream from a supply may permit a relatively small diameter opening to be incorporated.

In a variation of the FIG. 11 form, at least part of the containment apparatus and cover portion may be formed as one-piece components that are joined to produce the FIG. 11 configuration, or other configurations described herein or contemplated. For example, the one-piece components may be halves of the FIG. 11 system shape that are mirror images of each other on opposite sides of a vertical plane bisecting the FIG. 11, or other, configuration. Any number of the pieces may be formed and joined using cooperating connectors, and/or a component such as the component 62, etc. Other joinable “piece” constructions are contemplated—differing in number, shape, joining edge shape and orientation, etc.

In an alternative form, as shown in FIG. 12, a containment apparatus 10″ has a shape generally as the aforementioned containment volume 10, but additionally incorporates an annular collection rim/collar 66 with an annular upwardly facing surface 68 that accumulates ice cream product that flows over the top of the rim 42″. As depicted, the collection surface 68 is concave, opening upwardly to thereby create a collection volume. The radial projection of the rim/collar 66 from the outer peripheral surface 70 of the containment apparatus 10″ is identified by the distance D. The distance D may be on the order of ¼ inch to ¾ inch, with neither range limit being critical.

As depicted, the rim/collar 66 is closer to the top than the bottom of the containment apparatus 10″, although this is not a requirement. A like rim/collar 66a may be provided in place of, or in addition to, the collar 66, at the bottom of the containment apparatus 10″.

As shown in FIG. 13, the cover portion 16′″ may be configured to appear as at least part of an animate object such as a cartoon character, an inanimate object, a logo, etc. A specific exemplary dinosaur shape for the cover portion 16′″ is shown in FIG. 12.

Likewise, as shown in FIG. 14, at least part of the containment apparatus 10′″ may be configured to appear as part of an animate object such a cartoon character, an inanimate object, a logo, etc.

The different forms of cover portions and containment

apparatus, as described above, can be used interchangeably. For example, the cover portion 16′″ may be used on the containment apparatus 10, without any imitation of objects, etc., as on the containment apparatus 10′″.

Further, as noted above, the cover portions 16, 16′, 16″, 16′″ may not define any additional containment volume, as indicated generally at 18 in FIG. 1.

It is desirable that the particular cover portion have a wall, as shown at 72 for the exemplary cover portion 16, that defines a top of the containment apparatus 10 and extends over at least a part of the first open containment volume 14 as viewed from above.

The cover portion 16, when made with any of the aforementioned compositions, such as a cake-based composition, has thermal insulating properties. The cover portion, in addition to shielding the ice cream product in the containment apparatus from the sun, tends to limit environmental heat transfer to the ice cream product.

The invention is further directed to a method of making a consumable product as depicted in flow diagram form in FIG. 15. As shown at block 80, a containment apparatus and cover portion are obtained.

As shown at block 82, ice cream product is directed into the first containment volume.

As shown at block 84, ice cream product is directed into the additional containment volume after directing the ice cream product into the first containment volume.

The method may be carried out with the containment apparatus and cover portion either initially separated or together.

The edible material described that may make up part or all of the cover portion 16 and/or part or all of the containment apparatus 10 is not limited in nature. As just an example, the edible material may be a cake material containing at least one of wheat, flour, and sugar.

The foregoing disclosure of specific embodiments is intended to be illustrative of the broad concepts comprehended by the invention.

1. In combination:
a) a containment apparatus comprising an upwardly opening cup-shaped portion bounding a first open containment volume;
b) a cover portion that extends at least partially over the first open containment volume to at least one of: i) partially block the first open containment volume; and ii) create an additional containment volume in communication with the first open containment volume,
wherein the cover portion is made at least partially from an edible material; and
c) an ice cream product within at least the first containment volume,
wherein the cover portion has an opening through which the ice cream product can be directed into the first open containment volume.

2. (canceled)

3. The combination according to claim 1 wherein the containment apparatus is made at least partially from an edible material.

4. The combination according to claim 1 wherein the containment apparatus and the cover portion are separately formed components that are joined together.

5. The combination according to claim 4 wherein the containment apparatus is made at least partially from an edible material and the containment apparatus and the cover portion are joined using an edible adhering composition.

6. The combination according to claim 1 wherein the cover portion creates an additional containment volume in communication with the first open containment volume and the ice cream product is within the first open containment volume and the additional containment volume.

7. The combination according to claim 1 wherein the edible material is a cake material containing at least one of wheat, flour, and sugar.

8. The combination according to claim 1 wherein the cover portion has the shape of at least a part of an animate object, an identifiable inanimate object, and a logo.

9. The combination according to claim 1 wherein there is a single piece that defines at least a part of the containment apparatus and the cover portion.

10. The combination according to claim 4 wherein the containment apparatus is an off-the-shelf ice cream cone to which the cover portion is joined.

11. The combination according to claim 10 wherein an edible syrup is applied between parts of the cup-shaped portion and the cover portion to maintain the joined containment apparatus and cover portion together.

12. The combination according to claim 4 wherein there is a projection on one of the containment apparatus and cover portion that extends into a receptacle on the other of the containment apparatus and cover portion to facilitate consistent relative positioning of the joined containment apparatus and cover portion, wherein the one of the containment apparatus and cover portion has an annular shape extending around an axis and the projection extends only partly around the axis.

13. The combination according to claim 1 wherein the cover portion has a wall that extends over and blocks at least a part of the first open containment volume as viewed from above.

14. The combination according to claim 1 wherein the containment apparatus has an annular wall surface that is graspable in a hand of a user.

15. The combination according to claim 14 wherein the annular wall surface has a tapering diameter between a top and bottom of the containment apparatus.

16. The combination according to claim 1 wherein the containment apparatus has an annular outer wall surface between a top and bottom of the containment apparatus and the annular outer wall surface has a non-uniform diameter over at least a portion of the annular outer wall surface between the top and bottom of the containment apparatus.

17. The combination according to claim 4 wherein the cup-shaped portion has a top and bottom, an annular outer wall, and an annular upwardly facing surface spaced from the top of the annular outer wall to be closer to the top of the containment apparatus than the bottom of the containment apparatus and made from an edible material so that with the cover portion and containment apparatus joined together ice cream escaping from the first open containment volume is accumulated at and consumed with the annular upwardly facing surface.

18. The combination of the containment apparatus and cover portion as recited in claim 1.

19. A method of making a consumable product comprising the steps of:
obtaining a containment apparatus and cover portion as recited in claim 1; and
directing a quantity of flowable ice cream product through the opening in the cover portion to reside in the first open containment volume.

20. The method according to claim 19 wherein the step of obtaining a containment apparatus comprises obtaining a containment apparatus wherein the cup-shaped portion and cover portion are separate components, and further including the step of directing ice cream product into the first open containment volume with the cover portion separated from the containment apparatus, and thereafter joining the cover portion with the containment apparatus.

21. The method according to claim 20 further comprising the step of directing additional ice cream product through the cover portion, and into the additional containment volume with the cover portion operatively joined to the containment apparatus.

22. A method of making a consumable product comprising the steps of:
obtaining: a) a containment apparatus comprising an upwardly opening cup-shaped portion bounding a first open containment volume; and b) a cover portion that extends at least partially over the first open containment volume to at least one of: i) partially block the first open containment volume; and ii) create an additional containment volume in communication with the first open containment volume,
wherein the cover portion is made at least partially from an edible material; and
directing a quantity of flowable ice cream product through the cover portion adequate to reside in each of the first open containment volume and the additional containment volume.
